(19) United States
(12) Patent Application Publication
(10) Pub. No.: US 2010/0233484 A1
(43) Pub. Date: Sep. 16, 2010

(54) ELECTRICAL STEEL SHEET HAVING INSULATION COATING AND METHOD FOR MANUFACTURING SAME

(75) Inventors: Tomofumi Shigekuni, Tokyo (JP); Kazumichi Sashi, Tokyo (JP); Masaaki Kohno, Tokyo (JP); Yuka Komori, Tokyo (JP)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: JFE STEEL CORPORATION, Tokyo (JP)

(21) Appl. No.: 12/159,276

(22) PCT Filed: Dec. 26, 2006
(86) PCT No.: PCT/JP2006/326341

§ 371 Date: Jun. 26, 2008

(30) Foreign Application Priority Data
Dec. 28, 2005 (JP) 2005-377067
Dec. 22, 2006 (JP) 2006-345946

(51) Int. Cl. B32B 15/08; B32B 15/092; B32B 15/088; B32B 15/09; B32B 15/095; B32B 9/04; B05D 3/02

(52) U.S. Cl. 428/412; 428/418; 428/423.5; 428/423.7; 428/424.8; 428/425.8; 428/447; 427/386; 427/387

(57) ABSTRACT

An electrical steel sheet has an insulation coating having excellent corrosion resistance and punchability even without containing chromium and is prepared by applying a coating liquid on the surface of an electrical steel sheet, followed by baking the applied coating liquid, which coating liquid contains 100 parts by weight of polysiloxane polymer prepared by copolymerizing polysiloxane with one or more resins selected from acrylic resin, styrene resin, vinyl acetate resin, polyester resin, urethane resin, polyethylene resin, polypropylene resin, polyamide resin, polycarbonate resin, phenol resin, alkyd resin, and epoxy resin, and 1 to 50 parts by weigh of one or more compounds selected from melamine, isocyanate, silane coupling agent, and oxazoline, as a cross-linking agent.

### RELATED APPLICATIONS

This is a §371 of International Application No. PCT/JP2006/326341, with an international filing date of Dec. 26, 2006 (WO 2007/074928, published Jul. 5, 2007), which is based on Japanese Patent Application Nos. 2005-377067, filed Dec. 28, 2005, and 2006-345946, filed Dec. 22, 2006.

### TECHNICAL FIELD

This disclosure relates to electrical steel sheets having an insulation coating, and specifically relates to electrical steel sheets having an insulation coating which does not contain chromium, being used mainly in motors and transformers, friendly to the environment, free from toxic substances such as hexavalent chromium in the coating and also in the coating liquid for forming the coating.

### BACKGROUND

Insulation coating on an electrical steel sheet used for motors, transformers, and the like is requested to have not only interlaminar resistance but also varieties of characteristics such as convenience during working and forming and stability during storage and use. Furthermore, since electrical steel sheets are used in varieties of applications, there are developed various kinds of insulation coating responding to each application.

For example, when an electrical steel sheet is treated by punching, shearing, bending, and the like, the residual strain deteriorates the magnetic characteristics. To recover the deteriorated magnetic characteristics, stress relieving annealing is often applied to thus treated electrical steel sheet at an approximate temperature range from 750° C. to 850° C. On applying the stress relieving annealing, the insulation coating has to endure the annealing treatment.

The insulation coating is roughly grouped into three kinds: (a) inorganic coating which emphasizes weldability and heat resistance, and endures the stress relieving annealing (excluding organic resin, in principle); (b) semi-organic coating comprising an inorganic compound as the basis and containing an organic resin, which aims to have both punchability and weldability, and endures the stress relieving annealing; and (c) organic coating for special applications, which cannot be treated by stress relieving annealing. As of these, the ones for general use, which endure the stress relieving annealing, are (a) and (b) which are the coatings containing inorganic matter, both of which contain chromium compound in the coating. Particularly, the chromate-based insulation coating of (b) type, containing organic resin, is widely used owing to the considerable improvement of punchability compared with the inorganic-based insulation coating.

For example, Examined Japanese Patent Publication No. 60-36476 describes an electrical steel sheet having an electrical insulation coating, which is manufactured by applying a coating liquid on the surface of a steel sheet, followed by baking by a known method, which coating liquid is prepared by mixing a bichromate-based aqueous solution containing at least one kind of bivalent metal with 5 to 120 parts by weight of solid content of a resin emulsion (vinyl acetate and VeoVa™ at a ratio ranging from 90/10 to 40/60), and 10 to 60 parts by weight of an organic reducing agent, to 100 parts by weight of CrO₃ in the aqueous solution.

Most of that type of chromate-based coatings for electric steel sheet contains trivalent chromium as the steel sheet products, raising no toxicity problem. Since, however, toxic hexavalent chromium has to be used in the stage of coating liquid (coating liquid applied on the steel sheet to form an insulation coating), there is required to observe strict handling regulations as well as establishing satisfactory apparatus to secure good workplace environment.

Under the present state and responding to the recent increasing concern about the environment, also the field of electrical steel sheet faces the request of customers to supply products having insulation coating free from chromium.

As the technology using a main component other than chromic acid, many kinds of semi-organic insulation coatings containing inorganic colloid such as silica as the main component are disclosed. Owing to unnecessariness of handling toxic hexavalent chromium solution, those semi-organic insulation coatings containing inorganic colloid as the main component are highly advantageously used in view of environment. For instance, Japanese Patent Laid-Open No. 10-34812 discloses a method to improve the corrosion resistance of inorganic-colloid-based coating by regulating the quantity of Cl and S in the resin/silica coating to a specified level or below. The method improves the corrosion resistance of the product sheet in a humidity cabinet test environment. However, the corrosion resistance thereof under severe conditions such as salt spray cannot reach the level of the corrosion resistance of the case applying Cr-containing insulation coating. Furthermore, with the addition of silica, punchability also cannot reach the good level of the case applying Cr-containing insulation coating, as in the case of corrosion resistance.

The electrical steel sheet needs to have wet corrosion resistance and salt spray corrosion resistance, each under normal temperature environment, and corrosion resistance after high temperature treatment (stress relieving annealing) at 700° C. or above. Different from surface-treated steel sheet with plating of zinc, tin, or the like to have sacrifice corrosion prevention in a corrosive environment, the electrical steel sheet exposes the steel portion to the atmosphere. In that case, it is important to suppress cathodic corrosion by providing high grade barrier property as a coating characteristic, thus by rejecting water, oxygen, chlorine, and the like becoming the cause element of corrosion. To provide that high barrier characteristic, it is preferred to have continuous and dense structure such as that of inorganic coating.

On the other hand, to obtain good punchability, or to suppress wear in the mold after successive punching cycles, which wear is a drawback in punching, addition of a lubricant component to the coating is effective. However, when the coating is a mixed coating of inorganic and organic resins to establish both the corrosion resistance and workability, the continuity of coating deteriorates, and corrosion resistance deteriorates.

It could therefore be beneficial to provide electrical steel sheets having an insulation coating which has performance equivalent to or higher than that of Cr-containing insulation coating even as an insulation coating containing an inorganic matter free from Cr as the main component, giving excellent corrosion resistance and punchability.

### SUMMARY

The corrosion resistance of product sheets with silica-based chromate-free coating cannot fully be improved even by decreasing the amount of impurities such as Cl⁻ and SO₄²⁻, and the corrosion resistance thereof becomes nonuniform depending on the manufacturing conditions.

We confirmed in many cases that deterioration in corrosion resistance is accompanied by cracks in the coating. That is, since colloidal silica does not allow the silica to form a three-dimensional network (three-dimensional structure) at a baking temperature ranging from about 200° C. to about 300° C., thus the silica itself has no film-formability, which is presumably the cause of crack generation in the coating and of nonuniformily of corrosion resistance depending on the manufacturing conditions.

From the above, we found that formation of a three-dimensional network of —Si—O—Si— (or three-dimensional cross-linking) is important to form a coating having good corrosion resistance, and providing a means of forming the above three-dimensional network by polymerizing the polysiloxane with an organic resin (a polymer containing carbon). Furthermore, when the polysiloxane polymer is three-dimensionally cross-linked using a cross-linking agent such as melamine, isocyanate, silane coupling agent, and oxazoline, we found that electrical steel sheets having an insulation coating having more excellent characteristics in relation to the corrosion resistance after stress relieving annealing is obtained.

We thus provide:
(I) Forming Composite Material Integrating Inorganic Component with Organic Component
The inorganic component and the organic component (organic resin) are brought into composite (copolymerized) in the step of synthesizing the resin, instead of the conventional technology in which the inorganic component and the organic component are simply mixed together in the coating liquid. That is, polysiloxane (inorganic component) and one or more of organic resins such as acrylic resin are copolymerized, thus obtaining the polysiloxane polymer. Since, in the polysiloxane polymer (inorganic composite resin), the silanol group (—SiOH) of polysiloxane and the hydroxyl group (—OH) of organic resin are dehydrated-condensed to form covalent bond, this is a composite having strongly bonding the inorganic component with the organic component. The polysiloxane polymer has hardness and barrier performance of inorganic properties, and flexibility and workability of organic properties.
(II) Forming Three-Dimensional Network (Three-Dimensional Cross-Linking)
For further improving the barrier performance, the polysiloxane polymer is brought into three-dimensional cross-linking via a cross-linking agent. Cross-linking may be conducted using one or more cross-linking agents selected from the group consisting of melamine, isocyanate, silane coupling agent, and oxazoline, which show reactivity with both the polar groups of hydroxyl group in the organic resin and silanol group in the polysiloxane portion.

Selected aspects of our steel sheets and methods include:
(1) An electrical steel sheet having an insulation coating prepared by applying a coating liquid on the surface of an electrical steel sheet, followed by baking, which coating liquid contains 100 parts by weight of polysiloxane polymer prepared by copolymerizing polysiloxane with one or more resins selected from the group consisting of acrylic resin, styrene resin, vinyl acetate resin, polyester resin, urethane resin, polyethylene resin, polypropylene resin, polyamide resin, polycarbonate resin, phenol resin, alkyd resin, and epoxy resin, as the organic resin, and 1 to 50 parts by weight in total of one or more compounds selected from the group consisting of melamine, isocyanate, silane coupling agent, and oxazoline, as the cross-linking agent.
(2) The electrical steel sheet having the insulation coating according to (1), wherein the insulation coating contains one or more compounds selected from the group consisting of silica, silicate, alumina, titania, tin oxide, cerium oxide, antimony oxide, tungsten oxide, and molybdenum oxide, as the inorganic compound, by an amount of 75% by mass or less to the total solid content in the coating.
(3) The electrical steel sheet having the insulation coating according to (1) or (2), wherein the blending ratio of the polysiloxane to the total solid content in the insulation coating is 10% by mass or more and 90% by mass or less as SiO₂.
(4) A method for manufacturing an electrical steel sheet having an insulation coating, having the steps of: applying a coating liquid on the surface of an electrical steel sheet, which coating liquid contains 100 parts by weight of polysiloxane polymer prepared by copolymerizing polysiloxane with one or more resins selected from the group consisting of acrylic resin, styrene resin, vinyl acetate resin, polyester resin, urethane resin, polyethylene resin, polypropylene resin, polyamide resin, polycarbonate resin, phenol resin, alkyd resin, and epoxy resin, as the organic resin, and 1 to 50 parts by weigh of one or more compounds selected from the group consisting of melamine, isocyanate, silane coupling agent, and oxazoline, as the cross-linking agent; and baking the electrical steel sheet with the coating liquid applied on the electrical steel sheet.

### DETAILED DESCRIPTION

Our electrical steel sheets are steel sheets having an insulation coating. The insulation coating contains a composite resin (polysiloxane polymer) prepared by copolymerizing polysiloxane with an organic resin (polymer containing carbon) in advance. The chemical composition is important. With that insulation coating, there are provided corrosion resistance (specifically corrosion resistance of annealed sheet) and punchability equivalent to or higher than those of electrical steel sheets having a Cr-containing insulation coating.

### Electrical Steel Sheet

The description begins with an electrical steel sheet.

The electrical steel sheet (also referred to “electrical iron sheet”) before forming the coating may be the one having any composition, not specifically limited, if only it is a steel sheet (iron sheet) which is adjusted to have at least the specific resistivity to obtain the desired magnetic characteristics (such as low iron loss). Specifically preferred is to apply to medium to high grade electrical steel sheets containing sole Si or (Si+Al) in a range from about 0.1 to about 10.0% by mass, and giving about W_{15/50}≦5.0 W/kg.

The surface of the electrical steel sheet on which the insulation coating is to be formed may be subjected to arbitrary preliminary treatment such as degreasing by alkali or the like, pickling by hydrochloric acid, sulfuric acid, phosphoric acid, and the like, intensifying, and magnetic domain refining, and may be as-manufactured surface (untreated).

Although forming a third layer between the insulation coating and the steel sheet surface is not necessarily required, the third layer may be formed as needed. For example, ordinary manufacturing methods may form an oxide film of the metal of steel sheet between the insulation coating and the steel sheet surface. The step of removing the oxide film can be eliminated. Although a forsterite film may be formed depending on the manufacturing method, the step of removing the film can be eliminated.

### Insulation Coating

Next is the description about the insulation coating applied on the surface of the above steel sheet.

The insulation coating is obtained by applying a coating liquid containing polysiloxane and an organic resin, which are essential components described below, on the surface of the electrical steel sheet, followed by baking. In the preparation step, a polysiloxane polymer prepared by copolymerizing the polysiloxane with the organic resin in advance is added to the coating liquid.

### Polysiloxane

Polysiloxane is a polymer which has —Si—O— (siloxane bond) in the main molecular chain. The polysiloxane is copolymerized with an organic resin in advance. The copolymerization provides covalent bonds created by dehydration and condensation of silanol group (—SiOH) of the polysiloxane and hydroxyl group (—OH) or silanol group (—SiOH) (in the case that silanol group is introduced in the organic resin, in advance) of the organic resin, thereby providing a composite strongly bonding the inorganic component with the organic component. That is, since the inorganic component and the organic component form a three-dimensional network in advance, there can be obtained homogeneous coating free from cracks, and can be formed a coating having good corrosion resistance.

The blending ratio of polysiloxane to the total solid content in the insulation coating (or the total coating amount after baking) is preferably adjusted to a range of 10% by mass or more and 90% by mass or less as SiO₂. If the blending ratio thereof is less than 10% by mass, the percentage of remaining coating after stress relieving annealing becomes small so that the anti-sticking property deteriorates in some cases. When the blending ratio of polysiloxane increases, the coating becomes strong. If, however, the blending ratio thereof exceeds 90% by mass, the flexibility becomes insufficient, and the corrosion resistance may deteriorate depending on the manufacturing conditions. The blending ratio of polysiloxane to the total coating amount after the stress relieving annealing significantly increases owing to the decomposition of organic component (50%). Thus, the blending ratio thereof after the stress relieving annealing need not stay within the above preferable range.

On assessing the amount of polysiloxane, the term “as SiO₂” (i.e., in terms of SiO₂) means that the content of SiO₂ is calculated on the assumption that all the contained Si forms SiO₂. For example, when sole Si amount is measured, the amount is converted into the amount of “SiO₂,” and the ratio of the converted amount to the total coating is determined.

Although the particle size of polysiloxane is not specifically limited, a preferable size range is larger than 0.03 μm and smaller than 0.5 μm. That is, small particle size deteriorates the stability of solution so that the size is preferably regulated to larger than 0.03 μm in view of operability. Since smaller particle size is more preferred from the point of coating appearance, the size is preferably adjusted to smaller than 0.5 μm. The particle size is determined by observing particles under an electron microscope or the like to measure the maximum diameter and the minimum diameter for individual particles, and by calculating the average of them.

### Organic Resin (Polymer Containing Carbon)

Regarding the organic resin which is copolymerized with the above polysiloxane, the following resins are applicable: acrylic resin, styrene resin, vinyl acetate resin, polyester resin, urethane resin, polyethylene resin, polypropylene resin, polyamide resin, polycarbonate resin, phenol resin, alkyd resin, and epoxy resin. One or more resins selected from above-given resins are copolymerized with the polysiloxane. On forming a three-dimensional network by forming cross-links in the polysiloxane polymer, which is prepared by copolymerizing the polysiloxane with the organic resin, via —Si—O—C— bonds or —Si—O—Si—C— bonds, it is more preferable to have a functional group bondable to the side chain of the skeleton of the organic resin.

The blending ratio of polymer having carbon to the total solid content in the insulation coating is preferably regulated to 0.1 times or more the blending ratio of polysiloxane, (above given SiO₂ converted value).

### Polysiloxane Polymer

The degree of polymerization of the polysiloxane polymer is in an arbitrary range for applying without raising problem if only the degree provides the coating liquid.

The particle size of polysiloxane polymer is preferably adjusted to larger than 0.04 μm and smaller than 0.6 μm. If the size is smaller than 0.04 μm, the stability of solution deteriorates. If the size is 0.6 μm or larger, the coating becomes rough and the appearance deteriorates.

### Cross-Linking Agent

There is further added 1 to 50 parts by weight of cross-linking agent as the total of one or more of melamine, isocyanate, silane coupling agent, and oxazoline to 100 parts by weight of the polysiloxane polymer. Addition of cross-linking agent induces cross-linking between polysiloxane polymers, thus forming a further dense coating to improve corrosion resistance, specifically the corrosion resistance after the stress relieving annealing. If the added amount of cross-linking agent as the total is less than 1 part by weight, the effect of cross-linking cannot be attained, and the corrosion resistance after the stress relieving annealing becomes insufficient. If the added amount thereof exceeds 50 parts by weight, non-reacted cross-linking agent remains, which deteriorates the coating adhesion property and the hardness of the coating.

Adding to the above components, the following-given additives and other inorganic compounds and organic compounds can be added within a range that does not deteriorate the coating property and desired effects. On adding the following-given additives and other inorganic compounds and organic compounds, addition of excess amount thereof deteriorates the coating performance so that it is preferable to adjust the total amount of additives and other inorganic compounds and organic compounds to about 75% by mass or less to the total coating amount of the insulation coating, and more preferably about 50% by mass or less.

### Additive

Applicable additive includes known surface-active agent, rust-preventive agent, lubricant, and defoaming agent. The adding amount of the additive is preferably adjusted to about 30% by mass or less to the total solid content of the coating.

### Other Inorganic Compound and Organic Compound

The insulation coating can contain other inorganic compounds and/or organic compounds which are not copolymerized with polysiloxane at a level not to deteriorate the desired effects. As for the inorganic compound, for example, other oxide (sol) can be added if the liquid stability is assured. Applicable oxide (sol) includes silica (sol) (silica or silica sol, the same is applied in the following), alumina (sol), titania (sol), tin oxide (sol), cerium oxide sol, antimony oxide (sol), tungsten oxide (sol), and molybdenum oxide (sol). For the case of a specifically small blending ratio of polysiloxane, addition of inorganic compound is preferred to improve adhesion property, corrosion resistance, and anti-sticking property of annealed sheet. The inorganic compound is added preferably by an amount of 75% by mass or less, more preferably 40% by mass or less, to the total solid content in the coating. Preferably the addition amount thereof is 5% by mass or more, and more preferably 10% by mass or more.

The organic compound which is not copolymerized with polysiloxane includes an organic resin similar to the above-described organic resin which is copolymerized with polysiloxane.

Our steel sheets and methods obtain good coating characteristics without adding chromium compound. Therefore, from the point of preventing environmental pollution caused by the manufacturing process and by the products, preferably the insulation coating substantially does not contain chromium. The allowable chromium amount as an impurity is preferably regulated to 0.1% by mass or less as CrO₃ to the total mass of solid content (total coating amount) in the insulation coating.

### Manufacturing Method

The following is the description about the method for manufacturing the electrical steel sheet having the insulation coating.

The preliminary treatment for the electrical steel sheet used as the starting material is not specifically limited. Non-preliminary treatment or preliminary treatment is applicable. Preferred preliminary treatment includes degreasing by alkali or the like, and pickling by hydrochloric acid, sulfuric acid, phosphoric acid, and the like.

On the steel sheet, there is applied a coating liquid which contains above-described polysiloxane and the cross-linking agent. There are several known applicable methods of copolymerization to obtain the polysiloxane polymer, including the method of copolymerization of monomers, the method of preparing a polymer of one of the monomers, followed by copolymerizing the polymer with other monomer, and the method using one copolymer as the basis, while polymerizing other monomer or other copolymer as a branch.

After that, baking treatment is applied to the surface of the electrical steel sheet with the above coating liquid, thus forming the insulation coating on the electrical steel sheet. The treatment provides formation of dense and strong three-dimensional network in the coating.

At this step, the coating liquid preferably has the blending ratio of polysiloxane within a range from 10 to 90% by mass as SiO₂ to the total solid content. As described above, the blending ratio thereof of less than 10% by mass results in reduced percentage of remained coating after the stress relieving annealing, which may deteriorate the anti-sticking property. When the blending ratio of polysiloxane increases, the coating becomes strong. If, however, the blending ratio thereof exceeds 90% by mass, flexibility becomes insufficient, and the corrosion resistance may deteriorate depending on the manufacturing conditions.

The raw material of the coating to be applied on the electrical steel sheet is preferably aqueous or oily material of paste or the liquid type. From the point not to increase unnecessarily the coating thickness (coating weight), however, the raw material thereof is preferably of the liquid type with the basis of water or organic solvent. In the following description, the term “coating liquid” also includes the paste type in principle.

Applicable methods for applying the insulation coating adopts varieties of apparatuses used generally in industry, such as roll coater, flow coater, spray, knife coater, and bar coater.

Also for the baking method, ordinarily applied ones can be used, such as hot air type, infrared heating type, and induction heating type. The baking temperature may be at an ordinary level. To avoid thermal decomposition of the resin, however, the baking temperature is preferably selected to 350° C. or below, and a more preferable range is 150° C. or above and 300° C. or below.

### Coating Weight of Insulation Coating

Although the coating weight of the insulation coating is not specifically limited, it is preferred to regulate the range from 0.05 g/m² or more to 10 g/m² or less per one coating side, and more preferably from 0.1 g/m² or more to 10 g/m² or less per one coating side. If the coating weight thereof is less than 0.05 g/m², it is industrially difficult to attain uniform application and, in some cases, stable punchability and corrosion resistance cannot be attained. If the coating weight thereof exceeds 10 g/m², further improvement of coating performance cannot be obtained, and economy may be lost. The measurement of coating weight is conducted on the steel sheet which completed baking treatment and does not receive stress relieving annealing, and the measurement can adopt the weight method in which only the coating is dissolved in hot-alkali or the like, and the weight change before and after dissolving is determined.

A preferred range of coating weight after the stress relieving annealing is from about 0.01 g/m² or more to about 9.0 g/m² or less.

The insulation coating is preferably formed on both sides of the steel sheet. Depending on the objective, however, the insulation coating may be formed only on one side thereof. That is, depending on the objective, the insulation coating is formed only on one side of the steel sheet, while the other side is coated by another insulation coating, or the other side is left non-coated.

The applications of the electrical steel sheet having the insulation coating are not specifically limited. To utilize the heat resistance of the coating, however, a most suitable application is to use the electrical steel sheet being subjected to stress relieving annealing at an approximate temperature range from 750° C. to 850° C. For example, specifically suitable use is the manufacture of laminated iron cores by punching electrical steel sheets, and by applying stress relieving annealing to them, then by laminating them.

### EXAMPLES

### Example 1

We now refer to a series of selected, representative examples. However, our steel sheets and methods are not limited to these examples.

As the electrical steel sheet, there was adopted a fully processed electrical steel sheet which contained the steel components of 0.45% by mass Si, 0.25% by mass Mn, and 0.48% by mass Al, and which was treated by finish annealing having a sheet thickness of 0.5 mm. The coating liquid was prepared by adding the respective cross-linking agents given in Tables 1 and 3 to the polysiloxane polymers obtained by copolymerizing, in advance, polysiloxane with the respective organic resins under the respective conditions given in Tables 1 and 3. Thus prepared coating liquid was applied on the surface of the respective electrical steel sheets using roll coater. The coated steel sheets were baked in a hot-air furnace at a baking temperature of 230° C. as the peak metal temperature, thus prepared the respective specimens. For some of Examples and Comparative Examples, the chemicals given in Tables 1 and 3 were added as the component other than the polysiloxane polymer.

For thus prepared specimens (electrical steel sheets having insulation coating), the coating was dissolved in a boiling 50% NaOH aqueous solution, and the coating weight of the insulation coating was determined using the above-described weight method.

For thus obtained electrical steel sheets having insulation coating, the following-described coating characteristics were determined and evaluated.

### Corrosion Resistance—Product Sheet 1

To the specimens, humidity cabinet test (50° C., higher than 98% RH (relative humidity)) was given to evaluate the red rust generation rate after 48 hours by visual observation in terms of area percentage.

Judgment Criterion
A: Red rust area percentage: from 0% to less than 20%
B: Red rust area percentage: from 20% to less than 40%
C: Red rust area percentage: from 40% to less than 60%
D: Red rust area percentage: from 60% to 100%

### Corrosion Resistance—Product Sheet 2

To the specimens, salt spray test (35° C.) specified by JIS Z 2371 was given to evaluate the red rust generation rate after 5 hours by visual observation in terms of area percentage.

Judgment Criterion
A: Red rust area percentage: from 0% to less than 25%
B: Red rust area percentage: from 25% to less than 50%
C: Red rust area percentage: from 50% to less than 75%
D: Red rust area percentage: from 75% to 100%

### Corrosion Resistance after the Stress Relieving Annealing (Corrosion Resistance—Annealed Sheet)

To the specimens, annealing was given in nitrogen atmosphere under a condition of 750° C. for 2 hours. To thus obtained annealed sheets, constant temperature and humidity test (50° C. and 80% RH) was given to evaluate the red rust generation rate after 14 days by visual observation in terms of area percentage.

Judgment Criterion
AA: Red rust area percentage: from 0% to less than 5%
A: Red rust area percentage: from 5% to less than 20%
B: Red rust area percentage: from 20% to less than 40%
C: Red rust area percentage: from 40% to less than 60%
D: Red rust area percentage: from 60% to 100%

### Adhesion Property

To (i) the specimens and to (ii) the annealed sheets treated by annealing in nitrogen atmosphere under a condition of 750° C. for 2 hours, the bending and straightening test was given at 20 mmφ and 180°, thereby evaluated the adhesion property by visual observation in terms of coating peeling rate.

Judgment Criterion
A: No peeling occurred.
B: Peeling rate is less than 20%.
C: Peeling rate is 20% or more and less than 40%.
D: Peeling rate is 40% or more to entire area peeling.

### Solvent Resistance

A solvent (hexane) was impregnated in absorbent cotton. Let the impregnated cotton rub back and forth by five times on the surface of the specimen. The change in appearance after that was visually observed.

Judgment Criterion
A: No change occurred.
B: Very little change occurred.
C: Slightly discolored.
D: Significant change occurred.

### Flaw Resistance

An electrical steel sheet was sheared to give 20 μm in bur height. A weight of 20 mm in diameter and 500 g of weight was placed on the electrical steel sheet. Let the electrical steel sheet with the weight rub back and forth by three times in the horizontal direction on the surface of the test steel sheet. The generated flaw was visually evaluated.

Judgment Criterion
A: No change occurred.
B: Very little change occurred.
C: Slightly flawed.
D: Significant change occurred.

### Punchability

With a 15 mmφ steel die, the specimen was punched repeatedly until the bur height reached 50 μm. The evaluation was given by the number of punch cycles at the 50 μm height.

Judgment Criterion
A: One million cycles or more
B: 500 thousand cycles or more and less than one million cycles
C: 100 thousand cycles or more and less than 500 thousand cycles
D: less than 100 thousand cycles

### Anti-Sticking Property

Ten sheets of specimens each having 50 mm square size were stacked. The stacked specimens were annealed while applying a load (200 g/cm²) in nitrogen atmosphere under a condition of 750° C. for 2 hours. Then, a weight of 500 g was dropped onto the specimens (steel sheets), and the dropping height that induced breaking of the specimens into five segments was determined.

Judgment Criterion
A: 10 cm or less
B: more than 10 cm and not more than 15 cm
C: more than 15 cm and not more than 30 cm
D: more than 30 cm

Tables 2 and 4 show the results of the above tests.

TABLE 1

| | Polysiloxane polymer | | | | | | |
|---|---|---|---|---|---|---|---|
| | | Blending ratio of | | | | | |
| | | polysiloxane in | Cross-linking agent | | Other | | Coating |
| | Polymer | the polymer resin | Kind of | Blending | Kind of | Blending | weight |
| | resin | (%) (as SiO₂) | chemicals | ratio⁽⁴⁾ | chemicals | ratio⁽⁴⁾ | (g/m²) |
| Example 1 | Urethane | 20 | Melamine⁽¹⁾ | 10 | — | — | 0.7 |
| Example 2 | Urethane | 30 | Isocyanate | 15 | — | — | 0.8 |
| Example 3 | Urethane | 50 | Epoxy-based | 20 | — | — | 0.9 |
| | | | silane coupling | | | | |
| | | | agent⁽²⁾ | | | | |
| Example 4 | Urethane | 70 | Oxazoline | 30 | — | — | 1.0 |
| Example 5 | Acrylic | 25 | Epoxy-based | 15 | — | — | 0.8 |
| | | | silane coupling | | | | |
| | | | agent⁽²⁾ | | | | |
| Example 6 | Acrylic | 75 | Epoxy-based | 25 | — | — | 0.6 |
| | | | silane coupling | | | | |
| | | | agent⁽²⁾ | | | | |
| Example 7 | Vinyl acetate | 40 | Oxazoline | 30 | — | — | 0.7 |
| Example 8 | Vinyl acetate | 80 | Isocyanate | 10 | — | — | 0.8 |
| Example 9 | Polyester | 70 | Melamine⁽¹⁾ | 20 | — | — | 0.3 |
| Example 10 | Alkyd | 70 | Isocyanate | 20 | — | — | 0.5 |
| Example 11 | Epoxy | 70 | Epoxy-based | 20 | — | — | 0.7 |
| | | | silane coupling | | | | |
| | | | agent⁽²⁾ | | | | |
| Example 12 | Polyethylene | 70 | Oxazoline | 20 | — | — | 0.7 |
| Example 13 | Polypropylene | 70 | Epoxy-based | 20 | — | — | 0.8 |
| | | | silane coupling | | | | |
| | | | agent⁽²⁾ | | | | |
| Example 14 | Polyamide | 70 | Epoxy-based | 20 | — | — | 0.6 |
| | | | silane coupling | | | | |
| | | | agent⁽²⁾ | | | | |
| Example 15 | Phenol | 70 | Oxazoline | 20 | — | — | 0.7 |
| Example 16 | Polycarbonate | 70 | Isocyanate | 20 | — | — | 0.7 |
| Example 17 | Urethane | 20 | Melamine⁽¹⁾ | 10 | Silica sol | 50 | 0.5 |
| | | | | | (20 nm) | | |
| Example 18 | Urethane | 30 | Isocyanate | 15 | Silica sol | 120 | 0.3 |
| | | | | | (10 nm) | | |
| Example 19 | Acrylic | 25 | Epoxy-based | 15 | Silica sol | 100 | 1.6 |
| | | | silane coupling | | (10 nm) | | |
| | | | agent⁽²⁾ | | | | |
| Example 20 | Acrylic | 75 | Epoxy-based | 25 | Silica sol | 70 | 0.7 |
| | | | silane coupling | | (10 nm) | | |
| | | | agent⁽²⁾ | | | | |
| Example 21 | Epoxy | 70 | Epoxy-based | 20 | Silica sol | 240 | 1.8 |
| | | | silane coupling | | (10 nm) | | |
| | | | agent⁽²⁾ | | | | |
| Example 22 | Epoxy | 70 | Amine-based | 20 | Silica sol | 240 | 1.8 |
| | | | silane coupling | | (10 nm) | | |
| | | | agent⁽³⁾ | | | | |

⁽¹⁾Methylated melamine (Cymel 303, manufactured by Cyanamid Japan Ltd.)
⁽²⁾γ-glycydoxy-propyltrimethoxysilane (epoxy-based)
⁽³⁾N-2-(aminoethyl)-3-aminopropyltrimethoxysilane (amine-based)
⁽⁴⁾Added amount (parts by weight) to 100 parts by weight of solid content of the polysiloxane polymer

TABLE 2

| | Corrosion | Corrosion | Corrosion | Adhesion | Adhesion | | | | | |
|---|---|---|---|---|---|---|---|---|---|---|
| | resistance | resistance | resistance | property | property | Solvent | | | Anti- | |
| | product | product | annealed | product | annealed | resistance | Flaw | Punch- | sticking | |
| | sheet 1 | sheet 2 | sheet | sheet | sheet | (Hexane) | resistance | ability | property | Remarks |
| Example 1 | A | A | AA | A | A | B | B | A | B | |
| Example 2 | A | A | AA | A | A | B | B | A | B | |
| Example 3 | A | A | AA | A | A | B | B | A | B | |
| Example 4 | B | B | AA | A | A | B | B | A | B | |
| Example 5 | A | A | AA | A | A | B | B | A | B | |
| Example 6 | A | A | AA | A | A | B | B | A | B | |
| Example 7 | A | B | AA | A | A | B | B | A | B | |
| Example 8 | A | B | AA | A | A | B | B | A | B | |
| Example 9 | A | A | AA | A | A | B | B | A | B | |
| Example 10 | B | B | AA | A | A | B | B | A | B | |
| Example 11 | A | A | AA | A | A | B | B | A | B | |
| Example 12 | B | B | AA | B | B | B | B | A | B | |
| Example 13 | B | B | AA | B | B | B | B | A | B | |
| Example 14 | B | B | AA | B | B | B | B | A | B | |
| Example 15 | A | A | AA | A | A | B | B | A | B | |
| Example 16 | A | A | AA | A | A | B | B | A | B | |
| Example 17 | A | B | AA | A | A | A | A | B | B | |
| Example 18 | A | B | AA | A | B | A | A | B | B | |
| Example 19 | A | A | AA | A | B | A | A | B | B | |
| Example 20 | A | B | AA | A | B | A | A | B | B | |
| Example 21 | B | A | AA | A | A | A | A | B | B | |
| Example 22 | B | A | AA | A | A | A | A | B | B | |

TABLE 3

| | Polysiloxane polymer | | | | | | |
|---|---|---|---|---|---|---|---|
| | | Blending ratio of | | | | | |
| | | polysiloxane in the | Cross-linking agent | | Other | | Coating |
| | Polymer | polymer resin (%) | Kind of | Blending | Kind of | Blending | weight |
| | resin | (as SiO₂) | chemicals | ratio⁽⁴⁾ | chemicals | ratio⁽⁴⁾ | (g/m²) |
| Example 23 | Acrylic | 50 | Isocyanace | 20 | Na silicate | 50 | 2.5 |
| Example 24 | Acrylic | 40 | Melamine⁽¹⁾ | 20 | K silicate | 50 | 0.8 |
| Example 25 | Urethane | 50 | Isocyanate | 30 | Li silicate | 10 | 1.2 |
| Example 26 | Urethane | 50 | Epoxy-based | 40 | Alumina sol | 70 | 1.6 |
| | | | silane coupling | | | | |
| | | | agent⁽²⁾ | | | | |
| Example 27 | Acrylic | 50 | Epoxy-based | 40 | Titania sol | 25 | 0.8 |
| | | | silane coupling | | | | |
| | | | agent⁽²⁾ | | | | |
| Example 28 | Epoxy | 50 | Epoxy-based | 50 | Tin sol | 65 | 0.3 |
| | | | silane coupling | | | | |
| | | | agent⁽²⁾ | | | | |
| Example 29 | Acrylic | 50 | Melamine⁽¹⁾ | 20 | Cerium sol | 70 | 2.0 |
| Example 30 | Epoxy | 50 | Melamine⁽¹⁾ | 15 | Antimony sol | 25 | 0.4 |
| Example 31 | Urethane | 50 | Melamine⁽¹⁾ | 10 | Tungsten sol | 15 | 0.7 |
| Example 32 | Urethane | 50 | Isocyanate | 15 | Molybdenum sol | 280 | 1.5 |
| Example 33 | Acrylic | 5 | Epoxy-based | 15 | — | — | 4.0 |
| | | | silane coupling | | | | |
| | | | agent⁽²⁾ | | | | |
| Example 34 | Acrylic | 95 | Epoxy-based | 25 | — | — | 0.5 |
| | | | silane coupling | | | | |
| | | | agent⁽²⁾ | | | | |
| Example 35 | Acrylic | 5 | Epoxy-based | 15 | Silica sol | 100 | 0.9 |
| | | | silane coupling | | (10 nm) | | |
| | | | aget⁽²⁾ | | | | |
| Example 36 | Acrylic | 95 | Epoxy-based | 25 | Silica sol | 120 | 1.5 |
| | | | silane coupling | | (10 nm) | | |
| | | | agent⁽²⁾ | | | | |
| Example 37 | Styrene | 75 | Epoxy-based | 15 | Silica sol | 80 | 1.0 |
| | | | silane coupling | | (15 nm) | | |
| | | | agent⁽²⁾ | | | | |
| Comparative | Silica sol (20 nm)50:Urethane100 | | | | | | 1.2 |
| Example 1 | | | | | | | |
| Comparative | Acrylic | | | | | | 1.5 |
| Example 2 | | | | | | | |
| Comparative | Acrylic | 70 | — | — | — | — | 1.0 |
| Example 3 | | | | | | | |
| Comparative | Acrylic | 70 | Epoxy-based | 0.3 | Li silicate | 10 | 0.7 |
| Example 4 | | | silane coupling | | | | |
| | | | agent⁽²⁾ | | | | |
| Comparative | Acrylic | 70 | Epoxy-based | 55 | Silica sol | 120 | 0.9 |
| Example 5 | | | silane coupling | | (10 nm) | | |
| | | | agent⁽²⁾ | | | | |
| Comparative | Acrylic⁽³⁾ | 75 | — | — | — | — | 0.8 |
| Example 6 | | | | | | | |
| Comparative | Acrylic⁽³⁾ | 75 | Epoxy-based | 25 | — | — | 0.8 |
| Example 7 | | | silane coupling | | | | |
| | | | agent⁽²⁾ | | | | |

| | | |
|---|---|---|
| Reference | Cr-coating (Acrylic 100:Magnesium bichromate 350) | 0.9 |
| Example | | |

⁽¹⁾Methylated melamine (Cymel 303, manufactured by Cyanamid Japan Ltd.)
⁽²⁾γ-glycydoxy-propyltrimethoxysilane (epoxy-based)
⁽³⁾Applied coating liquid did not copolymerize polysiloxane with acrylic in advance
⁽⁴⁾Added amount (parts by weight) to 100 parts by weight of solid content of the polysiloxane polymer

TABLE 4

| | Corrosion | Corrosion | Corrosion | Adhesion | Adhesion | | | | | |
|---|---|---|---|---|---|---|---|---|---|---|
| | resistance | resistance | resistance | property | property | Solvent | | | Anti- | |
| | product | product | annealed | product | annealed | resistance | Flaw | Punch- | sticking | |
| | sheet 1 | sheet 2 | sheet | sheet | sheet | (Hexane) | resistance | ability | Property | Remarks |
| Example 23 | B | B | AA | B | A | A | A | B | B | |
| Example 24 | B | B | AA | A | A | A | A | B | B | |
| Example 25 | A | B | AA | A | B | A | A | B | B | |
| Example 26 | A | B | AA | A | B | A | A | B | B | |
| Example 27 | B | A | AA | A | A | A | A | B | B | |
| Example 28 | A | B | AA | A | B | A | A | B | B | |
| Example 29 | B | A | AA | B | B | A | A | B | B | |
| Example 30 | B | B | AA | B | B | A | A | B | B | |
| Example 31 | B | B | AA | B | A | A | A | B | B | |
| Example 32 | A | B | AA | A | A | A | A | B | B | |
| Example 33 | A | A | C | A | C | A | B | A | C | Blending ratio of |
| | | | | | | | | | | polysiloxane is |
| | | | | | | | | | | outside the |
| | | | | | | | | | | preferred range. |
| Example 34 | B | C | D | A | A | A | A | C | A | Blending ratio of |
| | | | | | | | | | | polysiloxane is |
| | | | | | | | | | | outside the |
| | | | | | | | | | | preferred range. |
| Example 35 | A | A | A | A | A | B | B | A | B | Corresponding to |
| | | | | | | | | | | Example 33 (smaller |
| | | | | | | | | | | blending ratio of |
| | | | | | | | | | | polysiloxane) + |
| | | | | | | | | | | inorganic compound |
| Example 36 | B | B | A | A | A | A | A | C | A | Corresponding to |
| | | | | | | | | | | Example 34 (larger |
| | | | | | | | | | | blending ratio of |
| | | | | | | | | | | polysiloxane) + |
| | | | | | | | | | | inorganic compound |
| Example 37 | B | B | AA | A | A | A | A | B | B | |
| Comparative | B | D | A | A | A | A | D | D | A | |
| Example 1 | | | | | | | | | | |
| Comparative | B | C | D | A | D | A | D | A | B | |
| Example 2 | | | | | | | | | | |
| Comparative | C | C | D | B | C | B | D | B | B | Absence of |
| Example 3 | | | | | | | | | | cross-linking |
| | | | | | | | | | | agent |
| Comparative | B | C | D | B | B | C | C | B | B | |
| Example 4 | | | | | | | | | | |
| Comparative | B | B | C | D | C | A | C | B | C | |
| Example 5 | | | | | | | | | | |
| Comparative | C | D | D | A | C | C | D | A | C | Absence of |
| Example 6 | | | | | | | | | | cross-linking agent, |
| | | | | | | | | | | Copolymerization |
| | | | | | | | | | | treatment was not |
| | | | | | | | | | | applied |
| Comparative | B | D | C | A | C | B | D | A | C | Copolymerization |
| Example 7 | | | | | | | | | | was not applied |
| Reference | A | B | AA | B | A | A | A | B | B | Cr contained. |
| Example | | | | | | | | | | |

As seen in Tables 1 to 4, our Examples gave excellent corrosion resistance, adhesion property, solvent resistance, flaw resistance, punchability, and anti-sticking property. In particular, our Examples having preferable range of polysiloxane blending ratio further improved the above characteristics. To the contrary, the Comparative Examples deteriorated one or more of corrosion resistance, adhesion property, solvent resistance, flaw resistance, punchability, and anti-sticking property.

### INDUSTRIAL APPLICABILITY

We provide electrical steel sheets having an insulation coating giving excellent corrosion resistance and punchability. The electrical steel sheets having the insulation coating do not contain chromium, and give performances such as corrosion resistance and punchability equivalent to or higher than those of Cr-containing insulation coating. Consequently, steel sheets and methods are friendly to the environment not only as the final products but also during the manufacturing process, and allows wide use including motors and transformers.

1-4. (canceled)

5. An electrical steel sheet having an insulation coating prepared by applying a coating liquid on the surface of an electrical steel sheet, followed by baking, which coating liquid contains 100 parts by weight of polysiloxane polymer prepared by copolymerizing polysiloxane with one or more resins selected from the group consisting of acrylic resin, styrene resin, vinyl acetate resin, polyester resin, urethane resin, polyethylene resin, polypropylene resin, polyamide resin, polycarbonate resin, phenol resin, alkyd resin, and epoxy resin, as the organic resin, and 1 to 50 parts by weight in total of one or more compounds selected from the group consisting of melamine, isocyanate, silane coupling agent, and oxazoline, as a cross-linking agent.

6. The electrical steel sheet according to claim 5, wherein the insulation coating comprises one or more compounds selected from the group consisting of silica, silicate, alumina, titania, tin oxide, cerium oxide, antimony oxide, tungsten oxide, and molybdenum oxide, as the inorganic compound, by an amount of 75% by mass or less to the total solid content in the coating.

7. The electrical steel sheet according to claim 5, wherein the blending ratio of the polysiloxane to the total solid content in the insulation coating is 10% by mass or more and 90% by mass or less as SiO₂.

8. The electrical steel sheet according to claim 6, wherein the blending ratio of the polysiloxane to the total solid content in the insulation coating is 10% by mass or more and 90% by mass or less as SiO₂.

9. A method for manufacturing an electrical steel sheet having an insulation coating, comprising:
applying a coating liquid on the surface of an electrical steel sheet, which coating liquid contains 100 parts by weight of polysiloxane polymer prepared by copolymerizing polysiloxane with one or more resins selected from the group consisting of acrylic resin, styrene resin, vinyl acetate resin, polyester resin, urethane resin, polyethylene resin, polypropylene resin, polyamide resin, polycarbonate resin, phenol resin, alkyd resin, and epoxy resin, as the organic resin, and 1 to 50 parts by weigh of one or more compounds selected from the group consisting of melamine, isocyanate, silane coupling agent, and oxazoline, as a cross-linking agent; and
baking the electrical steel sheet with the coating liquid applied on the electrical steel sheet.
